(19) United States
(12) Patent Application Publication
(10) Pub. No.: US 2008/0252411 A1
(43) Pub. Date: Oct. 16, 2008

(54) DISTRIBUTED SYSTEM FOR MANAGING MULTIPLE ITEMS

(76) Inventor: MARVIN POYNTER, Richmond, MN (US)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/744,836

(22) Filed: May 5, 2007

Related U.S. Application Data
(60) Provisional application No. 60/889,524, filed on Feb. 12, 2007.

(51) Int. Cl. G05B 19/00

(52) U.S. Cl. 340/5.1; 340/309.16

(57) ABSTRACT

Disclosed are distributed systems and methods for managing multiple items. An exemplary system includes a user interface that allows a user to specify a date and time of day. The exemplary system also includes a plurality of portable devices, which may be attached to objects, such as bracelets or documents. Each portable device includes a wireless receiver configured to receive a signal corresponding to a date and time of day specified at the user interface. When the specified time arrives, the portable device emits a sound to alert someone.

This Application claims the benefit of U.S. application Ser. No. 60/889,524 of Marvin Poynter filed Feb. 12, 2007 for REMOTE FINDER DEVICE AND SYSTEM, the contents of which are herein incorporated by reference.

### BACKGROUND OF THE INVENTION

1. Field of the Invention

This invention relates generally to managing items and, more particularly, to distributed systems and methods for managing multiple items.

2. Description of Related Art

People typically need to be reminded of items that have been previously noted, but then set aside, forgotten, or lost. To provide such reminders, personal computers may run applications such as calendars, organizers, and alerts. The utility of such applications, however, may be limited by the fact that a user must be at the personal computer to receive the reminder.

A personable digital assistant (PDA) may be sufficiently compact to use in a portable manner, and may run various applications such as calendars or daily organizers. After receiving an alert or reminder, however, there still remains the task of physical coordination of the people or materials required to deal with the item.

### SUMMARY OF THE INVENTION

To address the issue above, there is a method in a system including an object. The method comprises receiving a time from a user interface; initializing a value at the object in accordance with the time received in the previous step, by sending a signal toward the object and receiving the signal at the object; comparing the value to a reference; and conditionally activating circuitry attached to the object, depending on a result of the comparing step, to enable the emission of a human perceptible signal from the object, depending on a result of the comparing step.

According to another aspect of the present invention, a system comprises a user interface that allows a user to specify a date and time of day; and a plurality of portable devices. Each portable device includes a wireless receiver configured to receive a first signal, corresponding to a date and time of day specified at the user interface, a memory configured to be initialized in accordance with the first signal, comparator circuitry configured to compare the memory content to a reference value, and generate a second signal, and an output device configured to conditionally generate third signal, depending on the second signal, the third signal being human perceptible.

According to yet another aspect of the present invention, a system comprises means for receiving a time from a user interface; means for initializing a value at an object in accordance with a time received by the means for receiving, by sending a signal toward the object and receiving the signal at the object; means for comparing the value to a reference; and means for conditionally activating circuitry attached to the object, depending on a signal generated by the means for comparing, to enable the emission of a human perceptible signal from the object.

### BRIEF DESCRIPTION OF THE DRAWINGS

References are made to the following text taken in connection with the accompanying drawings, in which:

FIG. 1 shows a system in accordance with a first exemplary embodiment of the present invention.

FIG. 2 shows a flowchart describing a process performed in the first exemplary system.

FIG. 3 shows an item to be managed in the first exemplary system.

FIG. 4 shows a portable control unit in the first exemplary system.

FIG. 5A is a plan view of an exemplary remote alert unit.

FIG. 5B is a side view of the unit shown in FIG. 5A.

FIG. 6 is a block diagram describing circuitry in the unit shown in FIG. 4

FIG. 7 is a diagram of a data packet generated and transmitted by the unit shown in FIG. 4.

FIG. 8 is a block diagram describing circuitry in the unit shown in FIG. 5A.

FIG. 9 is a diagram emphasizing some circuitry shown in FIG. 8.

FIG. 10 shows the portable control unit in the first exemplary system.

FIG. 11 shows an aspect of one of the processes performed in the first exemplary system.

FIG. 12 shows the portable control unit in the first exemplary system.

FIG. 13 is a schematic view of a main or central unit according to the second exemplary system, including two LCD displays and a keypad.

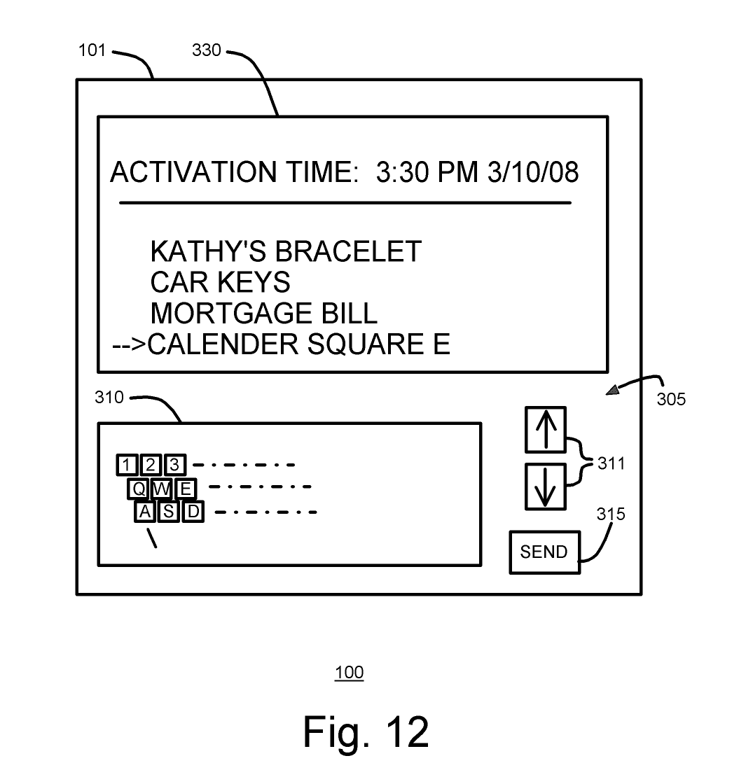

FIG. 11A is a front view of a remote receiver unit capable of being put on a key chain. having a speaker and reset button.

FIG. 14B is a back view of the device of HG 2A, having a 4 digit device address or identifier.

FIG. 15 is a front view of a remote receiver unit capable of being adhered to many objects, having a 4 digit address or identifier, a speaker, and rest button

FIG. 16A is a front view of a clip-on remote receiver unit having a 4 digit address or identifier, a speaker, a reset button, and a resilient clip.

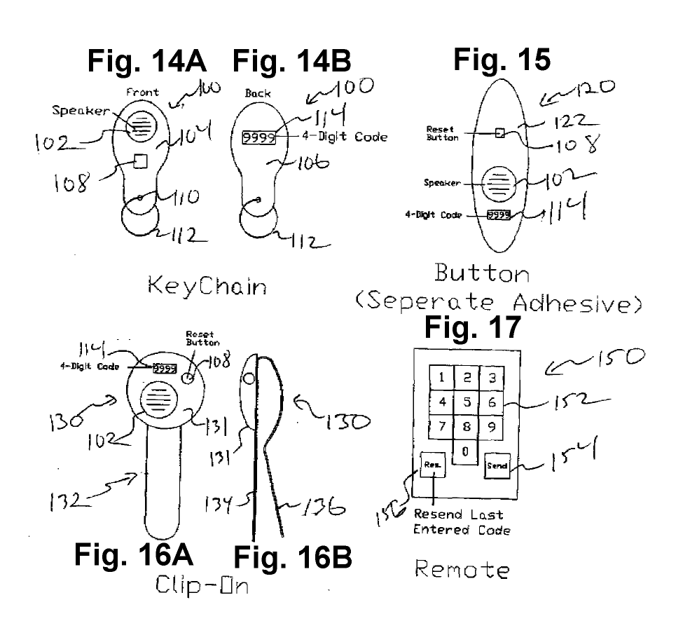

FIG. 16B is a side view of the device of FIG. 13A.

FIG. 17 is a front view of a remote unit capable of accepting remote receiver addresses and sending corresponding signals.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

### First Exemplary Embodiment

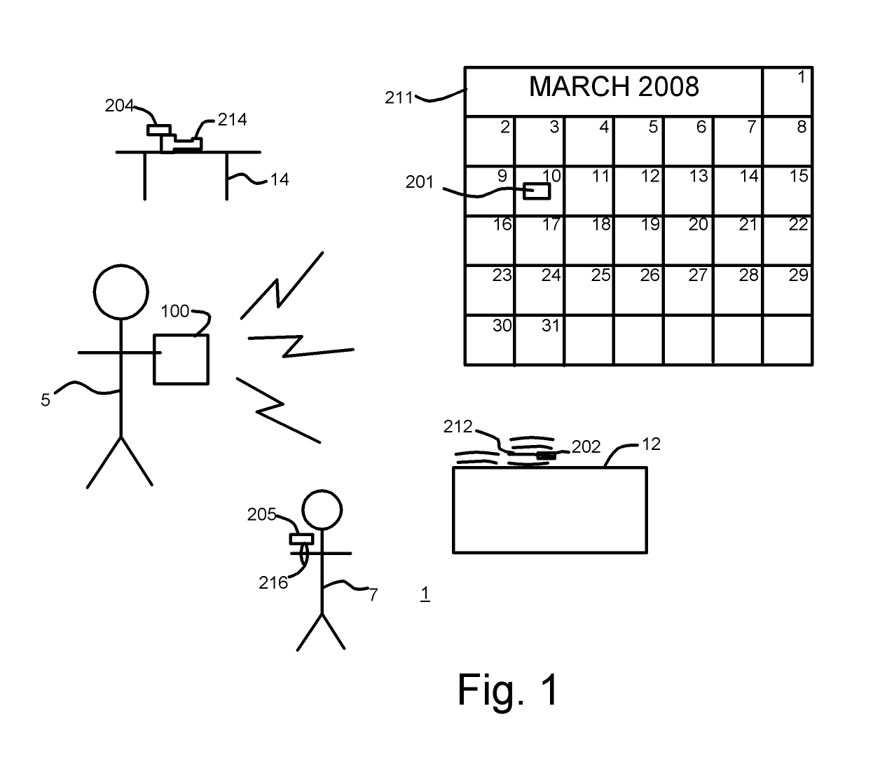

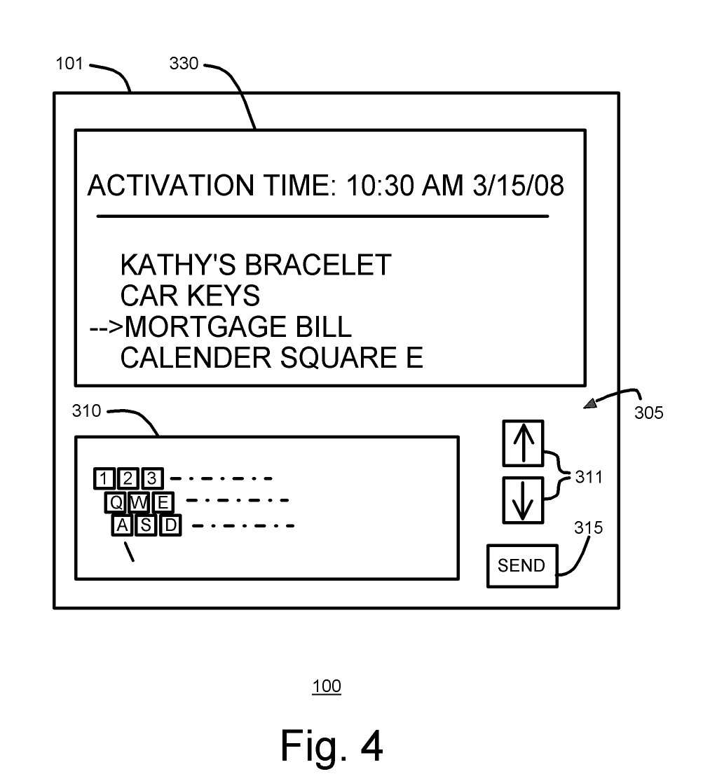

FIG. 1 shows system 1 including person 5 operating portable controller 100. Portable controller 100 includes user input interface 305 (FIG. 4) having a plurality of keys (buttons), and a display 330. Person 5 operates interface 305 to send a radio signal to alert unit 204, which is attached to automobile key 214 on table 14. The radio signal includes time data.

At the time indicated by the time data, described in the previous paragraph, alert unit 204 emits a human perceptible sound, to allow someone to easily locate and pick up keys 214.

Person 5 operates interface 305 to send a radio signal to alert unit 202, clipped onto paper bill 212 among other hardcopy documents on desk 12. The radio signal includes time data indicating a future time, subsequent to the current time but before the due date of bill 212.

Alert unit 202 receives the sent time data, described in the previous paragraph, and stores a corresponding number in a countdown timer in alert unit 202. Later, after the elapsed time indicated by the stored number, alert unit 202 emits a human perceptible sound, to allow someone to easily locate, pick up, and pay bill 212.

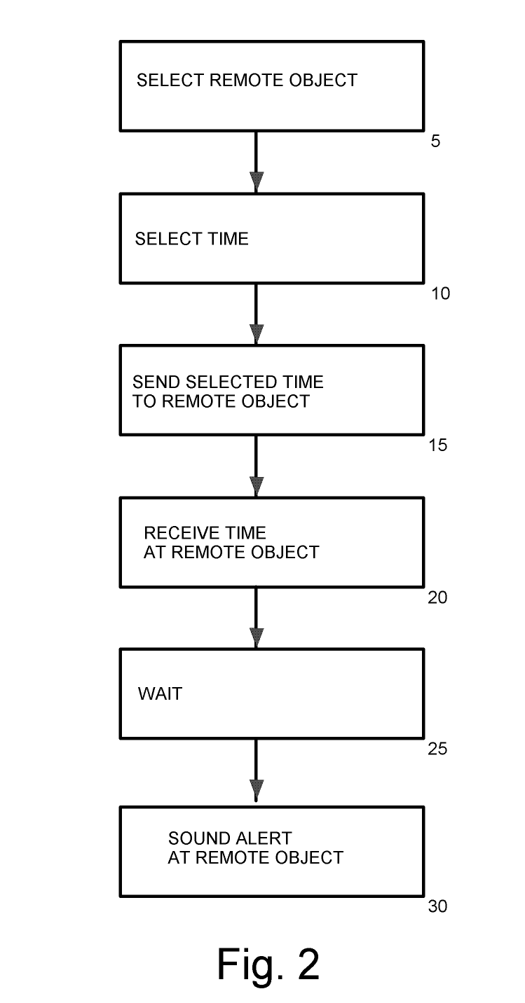

FIG. 2 shows a processing performed in system 1. Person 5 operates interface 305 to select a unit, in this case alert unit 202. (step 5). Person 5 operates interface 305 to specify a time, the time including a date and time of day. (step 10). Person hits send button 315 on interface 305, to send a signal to alert unit 202. (step 15). Alert unit 202 receives the signal, sent in the previous sentence, and stores a corresponding signal in a timer in alert unit 202. (step 20). Alert unit 202 waits for the time (step 25) and emits an audible sounds when the time has been reached (step 30).

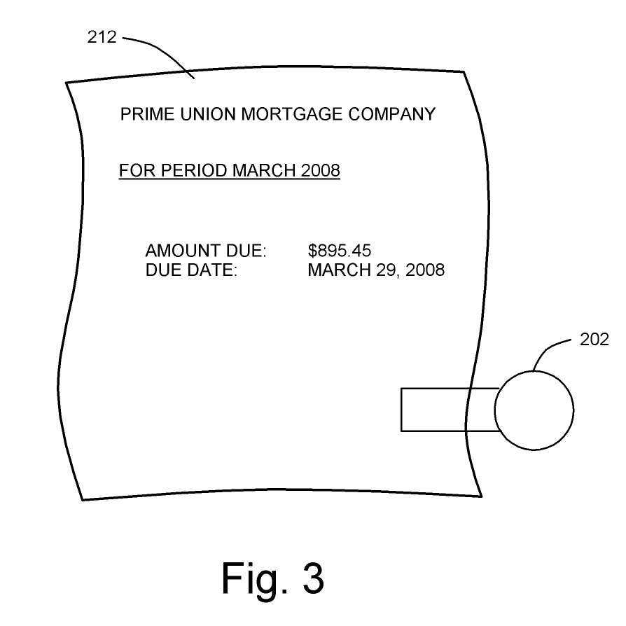

FIG. 3 shows alert unit 202 clipped onto bill 212. Bill 212 displays a due date of Mar. 29, 2008.

FIG. 4 shows portable controller 100 including housing 101, liquid crystal display (LCD) 330, and input interface 305 having alphanumeric keyboard 310 and send button 315. Keyboard 310 includes a respective switch (button) for each of the 26 letters of the English Language alphabet, A-Z (26 switches), and a respective switch for each of the digits 0-9 (10 switches).

User 5 manipulates keyboard 310 to select alert unit 202, which is the alert unit having the name “mortgage bill”. User 5 also manipulates keyboard 310 to select a time for alert unit 202 to emit an alert. Circuitry in portable controller 100 then sends a signal to LCD display 330, to cause LCD display 330 to display the selected time, which in this example is 10:30 AM 3/15/08.

In this Patent Application, the word circuitry encompasses dedicated hardware, and/or programmable hardware, such as a CPU or reconfigurable logic array, in combination with programming data, such as sequentially fetched CPU instructions or programming data for a reconfigurable array.

After viewing the selected alert unit and time on display 330, user 5 manipulates send button 315, to cause portable controller 100 to send a radio signal to alert unit 202. The radio signal includes time data, to instruct alert unit at 202 about the future time to emit the audible signal.

Portable controller 100 may be operated with two hands without placing portable controller 100 on a support such as a desk. For example, user 5 can hold portable controller 100 with his left hand while using his right hand to operate each of the controls of user input 305, including alphanumeric keypad 310, scroll keys 311, and send button 315.

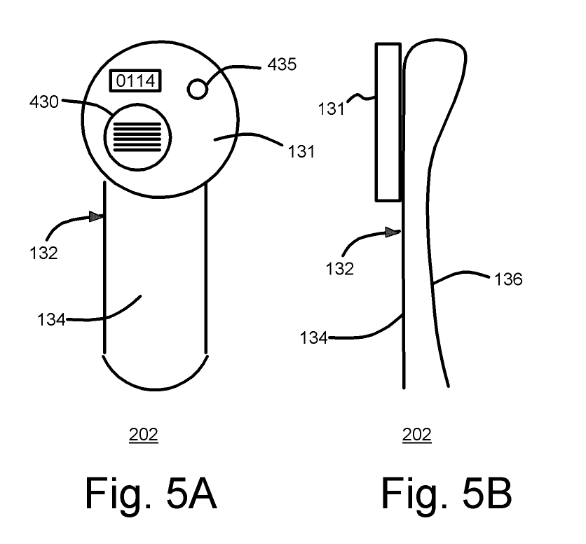

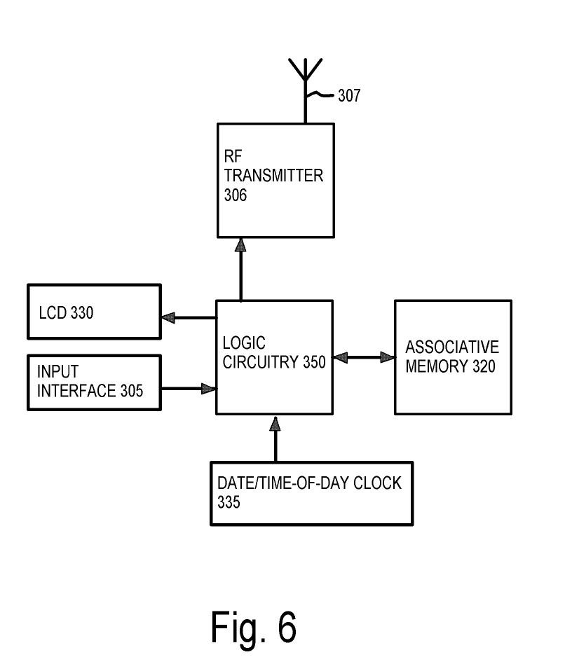

FIGS. 5A and 5B show alert unit 202 having speaker 430, front face 131, and reset button 435. Alert unit 202 also has a 4-digit code displayed on the exterior, the 4-digit code being 0114 in this example. Alert unit 202 also includes resilient clip 132 having a front portion 134 and a rear portion 136. Alert unit 202 can thus be attached to any number of different types of objects.

Portable Alert unit 202 has a simplified housing, without an alphanumeric keypad. In fact, the only input interface on unit 202 is reset button 435.

Thus, the housing of portable controller 100 is separate from the housings of each of units 201, 202, 204, and 205. The communication from portable controller 100 to each of units 201, 202, 204, and 205 is wireless.

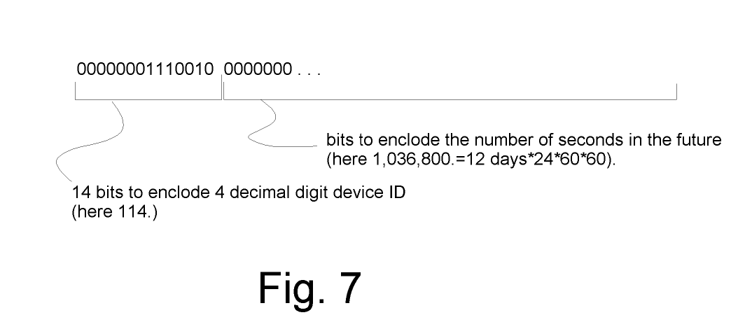

FIG. 6 shows a functional block diagram of circuitry in portable controller 100. Logic circuitry 350 receives a selected alert unit device name from user input interface 305, and accesses associative memory 320 to translate the device name into a four digit code for the named alert unit, each alert unit having a respective code. Memory 320 stores the codes 1374 (decimal), 0114, 1726, and 3408. Alert unit 201 includes logic to recognize code 1374, alert unit 202 includes logic to recognize code 0114, alert unit 204 includes logic to recognize code 1726, and alert unit 205 includes logic to recognize code 3408, for example.

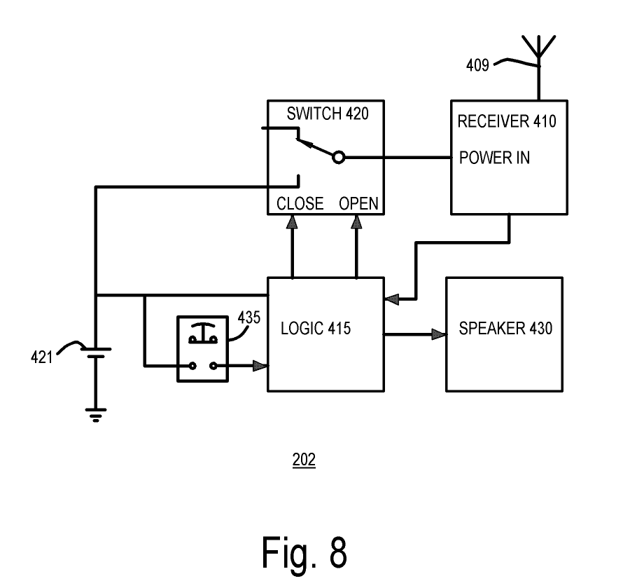

Logic circuitry 350 detects a user-selected date and time of day, by receiving signals from user input interface 305. Logic circuitry displays the user-selected date and time of day on LCD 330, allowing user 5 to view the user-selected date and time of day. When user 5 presses send button 315, logic circuitry 350 subtracts the current date and time of day received from date/time of day clock 335, to generate the number of seconds in the future at which alert unit device 202 should emit an audible sound. The resulting signal sent by RF transmitter 306 of portable controller 100 is shown in FIG. 7, including a four digit code to select alert unit 202 and the number of seconds in the future at which to emit the audible sound.

Portable external housing, or shell 101, encases logic circuitry 350, date/time-of-day clock 335, and radio frequency (RF) transmitter 306. Keyboard 310, scroll keys 311, send button 315 and LCD display 330 are on the exterior of housing 101.

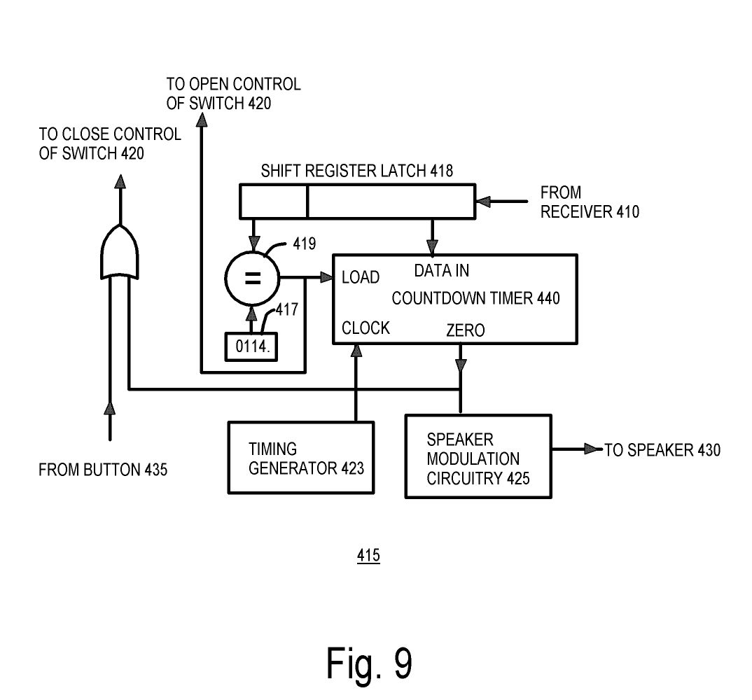

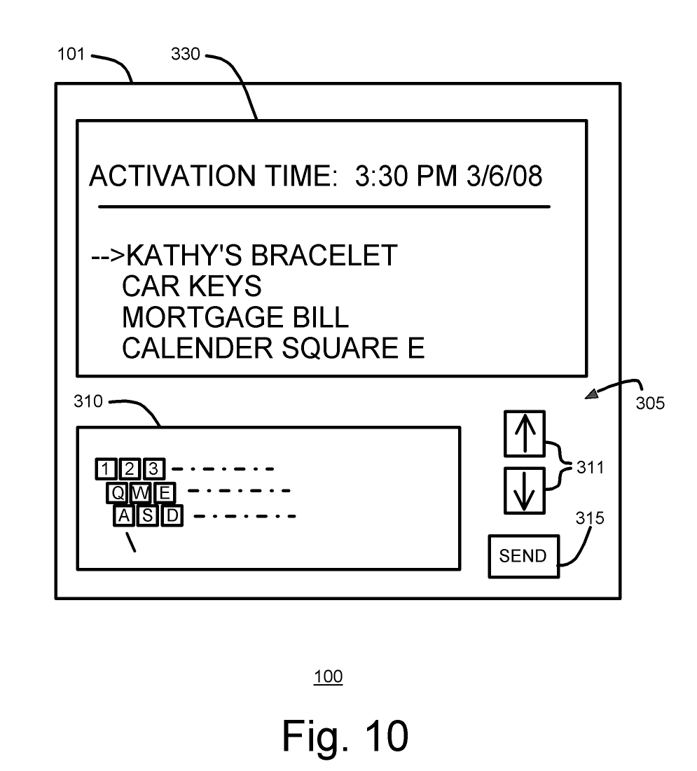

FIG. 8 shows circuitry in alert unit 202. Receiver 410 receives transmissions from controller 100, via antenna 409. Logic 415 includes circuitry to recognize the code of alert unit 202 in a received transmission and, when the code is recognized, latch (load) the time duration data in the received transmission. Logic 415 includes a count down timer 440 (FIG. 9), to count the received time duration down to zero, at which point logic 415 sends a signal to speaker 430 via circuitry 425.

More specifically, countdown timer 440 includes a register, which is one type of memory, configured to decrement at each rising edge on the “clock” input shown in FIG. 9. Countdown timer 440 includes a comparator that compares the register content to 0, and generates a rising edge on the “zero” output when the comparator signals that the register content is 0.

In summary, a method of managing an item includes selecting a time by receiving data from user interface 305; and sending data, corresponding to the selected time, to alert unit 202. Alert unit 202 initializes a value, corresponding to the sent data, and subsequently compares the value to a reference. Alert unit 202 conditionally activates speaker 430, depending on a result of the comparison, to enable the emission of a human perceptible sound.

Circuitry 350 is configured to accept an identifier signifying a remote receiver device, and command transmitter 306 to transmit a RF signal, corresponding to the remote receiver device, via antenna 307. More specifically, circuitry 350 is configured to accept keyboard signals, including alphabetical symbols from keyboard 310, and to associate those symbols with signals to be sent to the corresponding remote receiver device, by accessing memory 320.

Memory 320 is on a removable smart card, or IC card, that can be unplugged from unit 100 and plugged into a different unit 100.

Alert unit 202 includes a battery conservation feature wherein, after comparator 419 (FIG. 9) recognizes the four-digit code of the alert unit, causing the latching of the number of seconds to wait, logic 415 opens battery switch 420, to cut power to receiver 410, by opening the connection between receiver 410 and battery 421.

Logic 415 restores power to receiver 410, by closing the connection between receiver 410 and battery 421, after counting the time down to zero. Thus alert unit 202 can be reprogrammed after executing its alert task.

Alternatively, logic 415 restores power to receiver 410, by closing the connection between receiver 410 and battery 421, in response to receiving a signal from the reset button 435.

Thus, receiver circuitry 410 performs a step of receiving, and alert unit 202 acts to supply power to receiver circuitry 410; and responsive to data received in the receiving step, ceasing to supply the power. Alert unit 202 acts to restore power to receiver circuitry 410, responsive to a signal from button 435.

The structure of unit 201 is the same as the structure of unit 202, although the stored content in ID memory 417 in unit 201 is different from the stored content in ID memory 417 in unit 202. The stored content in ID memory 417 in unit 201 is 1374.

The structure of unit 204 is the same as the structure of unit 202, although the stored content in ID memory 417 in unit 204 is different from the stored content in ID memory 417 in unit 202. The stored content in ID memory 417 in unit 204 is 1726.

The structure of unit 205 is the same as the structure of unit 202, although the stored content in ID memory 417 in unit 205 is different from the stored content in ID memory 417 in unit 202. The stored content in ID memory 417 in unit 205 is 3408.

Memory 417 could be realized by any one of various structures, including a reprogramable memory, or a resistor array hard coded once at a factory.

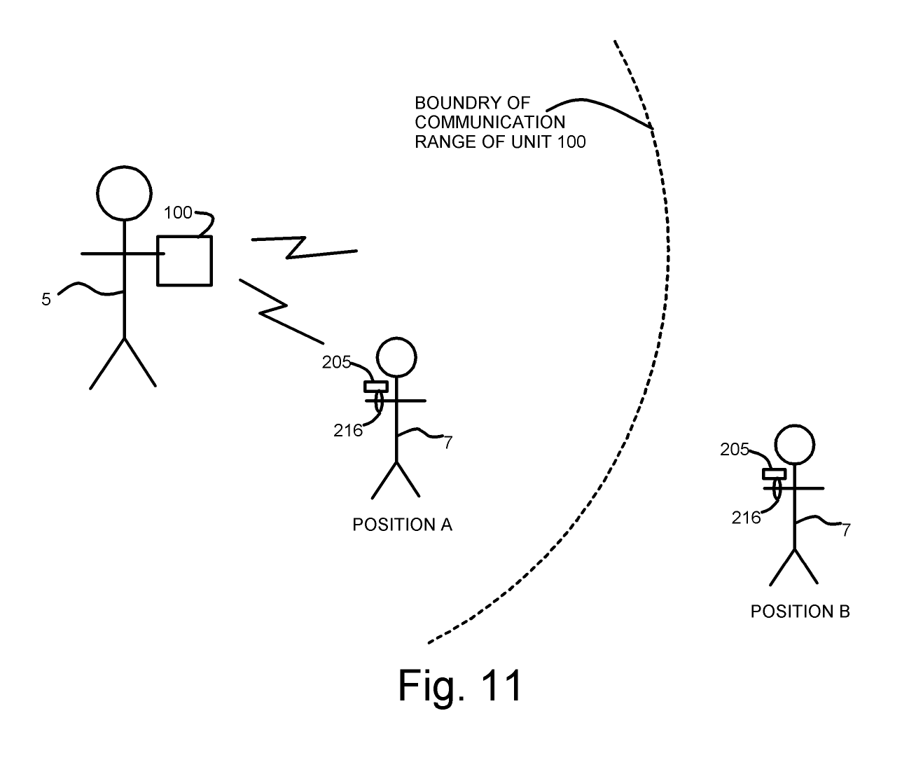

Another exemplary process in system 1 includes attaching unit 205 to the wrist of child 7 (named “Kathy”) via bracelet 216. As shown in FIG. 10, user 5 manipulates alphanumeric keyboard 310 and scroll keys 311, to select alert unit 205, which is the alert unit having the name “KATHY'S BRACELETS”. User 5 also manipulates keyboard 310 to select a time for alert unit 205 to emit an alert. Circuitry in portable controller 100 then sends a signal to LCD display 330, to cause LCD display 330 to display the selected time, which in this example is 3:30 PM 3/6/08.

After viewing the selected unit name, and alert time on display 330, as shown in FIG. 10, user 5 manipulates send button 315, to cause portable controller 100 to send a radio signal to units 201, 202, 204, and 205. The radio signal includes a code to identify unit 205, and time data to instruct unit at 205 about the future time to emit the audible signal.

As shown in FIG. 11, unit 205 receives a programming signal from portable controller 100 at a time when unit 205 is at position A. Subsequently, child 7 moves unit 205 to position B, which is outside of the communication range between portable controller 100 and unit 205. Position A may be inside of the same house as desk 12, table 14, and wall calendar 211. Position B may be outside of the house. For example, position B may be in a day care center for child 7.

Thus, there is no need for communications between controller 100 and remote unit 205 at the time unit 205 is to sound an alert. Another words, unit 205 may emit a human perceptible signal at a time when unit 205 is out of range of controller 100, or when controller 100 is inoperative.

Another exemplary process in system 1 includes attaching unit 201 to the square designated March 10, 2008 of calendar 211. Calendar 211 is made of paper, and is hanging on a wall.

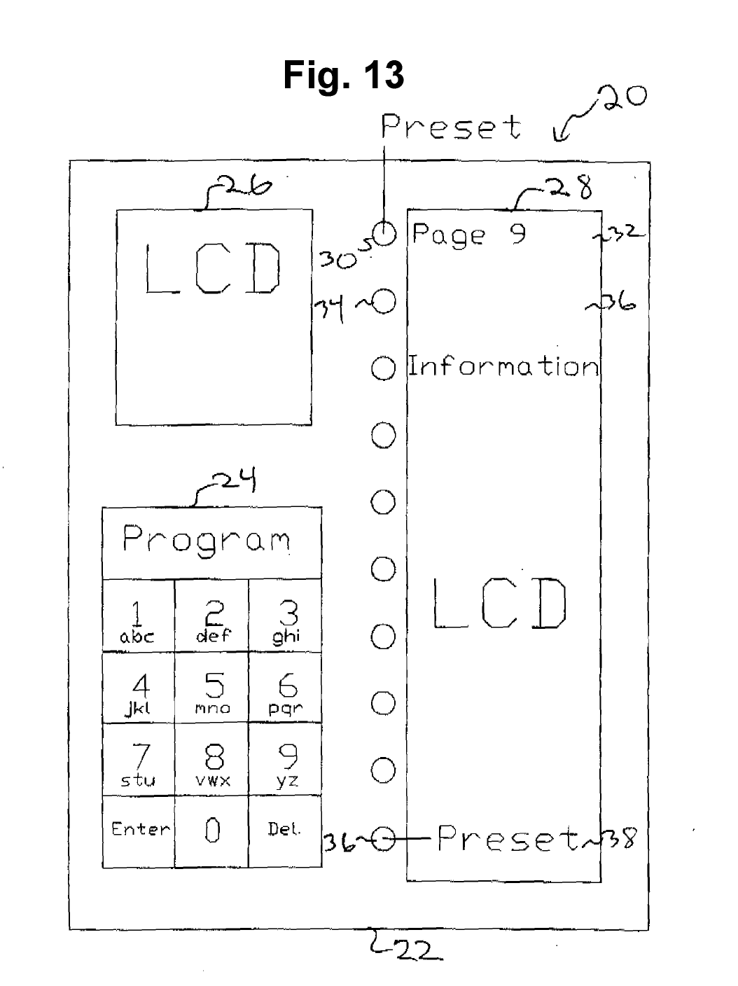

As shown in FIG. 12, user 5 manipulates alphanumeric keyboard 310 and scroll keys 311, to select alert unit 201, which is the alert unit having the name “CALENDAR SQUARE E”. User 5 also manipulates keyboard 310 to select a time for alert unit 201 to emit an alert. Circuitry in portable controller 100 then sends a signal to LCD display 330, to cause LCD display 330 to display the selected time, which in this example is 3:30 PM 3/10/08.

After viewing the selected unit name, and alert time on display 330, as shown in FIG. 12, user 5 manipulates send button 315, to cause portable controller 100 to send a radio signal to units 201, 202, 204, and 205. The radio signal includes a code to identify unit 201, and time data to instruct unit at 201 about the future time to emit the audible signal.

In other words hardcopy paper calendar 211 has a respective square for each day in March 2008. An exemplary method includes attaching unit 201 on the square for March 10, 2008, and a sending a time signal to unit 201, the time signal corresponding to March 10, 2008. (The time signal is the difference in seconds between the future date/time (the “ACTIVATION TIME”), and the date/time when user 5 hits SEND button 315.)

Calendar 211 and bill 212 are each examples of a document associated with a respective future date.

Thus each of units 201, 202, 204 and 205 can be attached to an object, and effectively programmed hours, weeks and even years, prior to the time an alert is to be sounded.

### Second Exemplary Embodiment

FIG. 13 shows a unit 20 in accordance with a second exemplary embodiment of the present invention.

The second exemplary system provides a system for signaling the location of a plurality of misplaced items. Unit 20 may include an electronic controller; a keypad coupled to the electronic controller; a radio frequency transmitter coupled to the controller; and a display coupled to the controller. The controller can include executable logic for accepting an identifier signifying a remote receiver device and executable logic for transmitting a radio signal corresponding to the remote receiver device. The controller can also include executable logic for accepting keypad entries including alphabetical symbols and logic to associate those symbols with signals to be sent to the corresponding remote receiver device.

The system can include a plurality of remote receiver devices each having a controller, a radio receiver, an annunciator coupled to the controller, and executable logic in the controller for receiving a plurality of radio signals and accepting a unique radio signal corresponding to each remote receiver device, in which receiving and accepting the unique radio signal triggers the annunciator to send an audible and/or visible signal to announce the remote receiver device location.

The remote receiver device controller further comprises executable logic for receiving a time signal and for triggering the annunciator when a time corresponding to the received time signal has been reached. In some systems, the annunciator provides an audible signal, a visible signal, a tactile signal, or combinations.

The second exemplary system may include a repeater for accepting the radio signals from the main device and re-transmitting the signals.

Unit 20 can further include logic for accepting a number of times to repeat the signal transmission and logic to send the signal that number of times. Some main devices include logic for accepting an amount of time to send the signal transmission and logic to send the signal that amount of time. The main device may also include a solid state memory device for storing information containing any user programming. Some remote receiver devices include a resilient clip, an aperture capable of receiving a key ring therethough, and/or an adhesive device for securing the device to another object.

As shown in FIG. 13, unit 20 includes a first LCD display 26, a second LCD display 28, a housing 22, and a keypad 24. Keypad 24 can include several alphanumeric keys. The keys may be laid out similar to a telephone or cell phone. In the illustrated example, there are also Enter. Delete, and Program keys. In some embodiments, depressing the keypad causes the main device to enter a programming mode for changing the display, entering alarm times, number of repeats, and the like. In some embodiments, keypad 24 is configured, through internal controller logic, to accept alphabetic and numerical symbols, in a manner similar to texting on cellular telephones. The main device can be wall powered in some embodiments, with a battery backup also being provided in some such devices.

The program button, once entered, can be used in conjunction with the LCD screens to allow for programming the main device with data entry and multiple choice responses to displayed entries.

In one embodiment, the system comes with a set of remote receivers intended to be fixed to objects to be located or have attention drawn to. The remote receivers can have some human readable indicia such as 4 digit numbers. The same human readable indicia can be visible on each remote receiver, again, for example, a 4 digit number. In other embodiments, alphabetic or alphanumeric indicia can be used.

In one example, remote receiver 0001 is labeled with that number, and also the label “TV Remote.” Remote receiver 0002 is labeled with that number, and also the label “Car Keys.” Remote receiver 0003 is labeled with that number and also the label “Briefcase.”

In some embodiments, the first 4 or 8 remote receivers are pre-labelled.

The pre-labelled devices are also displayed in display 28. In one example, the first preset button 30 is next to displayed line “TV Remote” and also “0001”, which in alternate embodiments, are displayed at the same time or upon toggling of the display LCD screen. In this way, the common devices can be preset or preprogrammed. If the remote receivers are used for other objects, the preset displays can be changed through use of the program key.

In some embodiments, LCD screen 28 has several pages, which are preset with the numbers (e.g. 0001, etc.) and/or the labels (e.g. TV Remote). While the indicia or numbers (e.g. 0001) are not typically changeable, the associated text (e.g. TV remote) can be. In some embodiments, the preset text can be changed (e.g. from T.V. remote to Cat).

Unit 20 includes a timer function. This function allows the remote receivers to alarm at a certain time and date and/or at an elapsed time in the future. In some embodiments, device 20 can be programmed to send out a signal to a specific remote receiver at a specific time and date. In other embodiments, the remote receivers have a calendar and clock and/or an elapsed time timer. In these embodiments, the remote receivers can be sent the date and time and/or the elapsed time, and then alarm when this condition is met, even if the remote receivers are out or range of the central unit.

In some embodiments, a numerical indicia of the remote receiver can be entered directly into the keypad e.g. “0002”, causing the remote receiver to alarm. The alarm can he audible, visual, and/or tactile (e.g. vibrating).

FIG. 14A illustrates a keychain adaptable remote receiver 100 having a front face 104. Remote receiver 100 includes a speaker or other annunciator 102, a reset button 108, an aperture 110 for receiving a key ring, wire ring, clip, or other connecting device, for example, a lanyard loop or clip. Reset button 108 can be used in some embodiments to silence the annunciator once the device has been found. The button may also be used in some embodiments to turn the device on and off through a sustained depressing of the reset button. In some embodiments, annunciator 102 includes a piezoelectric sound generator, a light source, a vibration source, or combinations of these functionalities.

FIG. 14B illustrates remote receiver device 100 from the back, having back surface 106 and a four digit code 114 for identifying the address or identifier of the remote receiver. Device 100 can be attached to many objects, including key chains, key rings, lanyards, belt loops, etc. The 4 digit code can be keyed into the main device or a remote device in order to trigger the unit. The 4 digit code can also be used in conjunction with a timer in the main device or a timer in the remote device to trigger the remote device at some time in the future.

FIG. 15 illustrates another remote receiver device 120 having a front face 122, a 4 digit code 114, speaker 102, and reset button IOB, as previously described. Remote receiver 120 can be in a smaller button form, and may be secured to remote objects using temporary or permanent adhesive, such as double sided sticky tape or hook and loop fasteners.

FIGS. 14A and 14B illustrate another remote receiver device 130 having speaker 102, front face 131, reset button 108, and 4 digit code 114. A resilient clip 132 having a front portion 134 and a rear portion 136 may also be seen in device 130. Device 130 can be used to clip the remote receiver to any number of things, including but not limited to files, books, glass cases, unpaid bills, and the like.

FIG. 17 illustrates a remote transmitter or transceiver (depending on the embodiment) 150 having a keypad 152, a send button 154, and a resend button 156. Remote device 150 can he used to key in any of the 4 digit codes of the corresponding remote receiver devices to trigger the remote receiver. Remote device 150 can be carried to remote locations away from the main unit, in order to find objects in the yard, at a cabin, or at any other location.

Systems and kits incorporating some or all of the devices listed herein are explicitly within the scope of the invention.

Each unique 4 digit code can be associated with a unique series of pulses or frequency shifts in series, When this 4 digit code is typed into the keypad, the associated signal can be transmitted, and the associated remote receiver device can be triggered, provided it is in range. In some systems or kits, a remote repeater can be used to extend the range of the system.

There are various ways that the remote receiver units may self-activate at the future time. For example, the central transmitter may transmit a time increment, or time duration, and the remote receiver may use an internal clock, ticker, or timing generator, to count the time increment down to zero. Alternatively, the central transmitter may transmit an absolute time, including date and time of day, to a remote receiver, and the remote receiver may use an internal clock to compare the received absolute time to the current time.

Throughout the Patent Application, certain functionality or processing may be depicted in serial, parallel, or other fashion, for ease of description. Actual hardware and software realizations, however, may be varied depending on desired optimizations apparent to one of ordinary skill in the art. For example, comparator 419 may be realized by sequentially fetched executable software instructions, or by dedicated hardcoded hardware.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described.

Accordingly, departures may be made from such details without departing from the spirit or the scope of Applicants' general inventive concept. The invention is defined in the following claims. In general, the words “first,”“second,” etc., employed in the claims do not necessarily denote an order.

What is claimed is:

1. In a system including an object, a method comprising:
receiving a time from a user interface;
initializing a value at the object in accordance with the time received in the previous step, by sending a signal toward the object and receiving the signal at the object;
comparing the value to a reference; and
conditionally activating circuitry attached to the object, depending on a result of the comparing step, to enable the emission of a human perceptible signal from the object, depending on a result of the comparing step.

2. The method of claim 1 further including displaying the time before sending the signal toward the object.

3. The method of claim 1 wherein the system further includes a transmitter that performs the sending step, and the method further includes emitting the human perceptible signal at a time when the object is out of range of the transmitter.

4. The method of claim 1 wherein receiving circuitry performs the step of receiving, and the method further includes the steps, performed by the circuitry, of
supplying power to the receiving circuitry; and
responsive to the receiving step, ceasing to supply the power to the receiving circuitry.

5. The method of claim 4 wherein the system further includes a button, and the method further includes the of restoring power to the receiving circuitry, responsive to a signal from the button.

6. The method of claim 1 wherein the object includes a document.

7. The method of claim 6 wherein the document is a bill.

8. The method of claim 7 wherein the bill displays a bill due date and wherein sending a time includes sending a date that is after the current date and before the bill due date.

9. The method of claim 1 wherein the object includes a hardcopy calendar.

10. The method of claim 9 wherein the hardcopy calendar has a respective position corresponding to a date, and the method further includes
attaching the circuitry at the position, and the step of sending a time includes sending the date.

11. The method of claim 1 wherein the human perceptible signal includes an audible sound.

12. The method of claim 1 wherein the human perceptible signal includes a light signal.

13. The method of claim 1 wherein the user interface includes a keyboard.

14. The method of claim 1 wherein the system further includes a portable housing having a keyboard and a transmitter, and the method further includes
receiving signals from the keyboard;
generating the time in accordance with the received signals, wherein the step of sending includes sending using the transmitter.

15. A system comprising:
a user interface that allows a user to specify a date and time of day; and
a plurality of portable devices, each portable device including
a wireless receiver configured to receive a first signal,
corresponding to a date and time of day specified at the user interface,
a memory configured to be initialized in accordance with the first signal,
comparator circuitry configured to compare the memory content to a reference value, and generate a second signal, and
an output device configured to conditionally generate third signal, depending on the second signal, the third signal being human perceptible.

16. The system of claim 15 wherein each portable device includes a housing having less than 26 buttons.

17. The system of claim 15 wherein each portable device includes a housing having less than 10 buttons.

18. The system of claim 15 wherein each portable device includes a housing having less than 2 buttons.

19. The system of claim 15 wherein each portable device includes a housing having only 1 button, the button being a reset button.

20. A system comprising:
means for receiving a time from a user interface;
means for initializing a value at an object in accordance with a time received by the means for receiving, by sending a signal toward the object and receiving the signal at the object;
means for comparing the value to a reference; and
means for conditionally activating circuitry attached to the object, depending on a signal generated by the means for comparing, to enable the emission of a human perceptible signal from the object.
